(19) United States
(12) Patent Application Publication
(10) Pub. No.: US 2025/0178040 A1
(43) Pub. Date: Jun. 5, 2025

(54) PRESSURE WASHER

(71) Applicant: Nanjing Chervon Industry Co., Ltd., Nanjing (CN)

(72) Inventors: Pengpeng Cao, Nanjing (CN); Bowei Xu, Nanjing (CN); Yang Gu, Nanjing (CN); Yangjian Xu, Nanjing (CN); Ming Hu, Nanjing (CN); Hehan Liu, Nanjing (CN); Jifeng Feng, Nanjing (CN)

(21) Appl. No.: 18/942,894

(22) Filed: Nov. 11, 2024

(30) Foreign Application Priority Data
Nov. 30, 2023 (CN) 202311634259.7
Nov. 30, 2023 (CN) 202311635846.8
Nov. 30, 2023 (CN) 202323258726.9
Nov. 30, 2023 (CN) 202323271452.7

(51) Int. Cl. B08B 3/02; B08B 13/00

(52) U.S. Cl. CPC B08B 3/026; B08B 13/00; B08B 2203/0211; B08B 2203/0223; B08B 2203/0276

(57) ABSTRACT

A pressure washer includes a housing formed with a battery holder and a drive compartment; a battery pack accommodated in the battery holder; a control board disposed in the housing; a drive assembly disposed in the drive compartment and including a pump and an electric motor for driving the pump; and a water gun connected to the pump through a water pipe. The housing is provided with an air inlet and an air outlet, a heat dissipation air path is formed between the air inlet and the air outlet, the heat dissipation air path is located inside the housing, and from the air inlet to the air outlet, the battery holder and the control board are located on the heat dissipation air path in sequence.

### RELATED APPLICATION INFORMATION

This application claims priority to Chinese Patent Application No. CN 202311635846.8 filed on Nov. 11, 2023, Chinese Patent Application No. CN 202323258726.9 filed on Nov. 11, 2023, Chinese Patent Application No. CN 202323271452.7 filed on Nov. 11, 2023, and Chinese Patent Application No. CN 202311634259.7 filed on Nov. 11, 2023, the disclosures of which are incorporated herein by reference in their entireties.

### TECHNICAL FIELD

The present application relates to a cleaning device and, in particular, to a pressure washer.

### BACKGROUND

A pressure washer is a machine that uses a power device to make a high pressure plunger pump generate high pressure water to wash the surface of an object. The pressure washer can peel off and wash away dirt to achieve the purpose of cleaning the surface of the object. In the related art, the heat of a control board is dissipated through only a cooling fan on the control board, and the heat dissipation effect is poor.

This part provides background information related to the present application, and the background information is not necessarily the existing art.

### SUMMARY

The present application adopts the technical solution below. A pressure washer includes a housing formed with a battery holder and a drive compartment; a battery pack accommodated in the battery holder; a control board disposed in the housing; a drive assembly disposed in the drive compartment and including a pump and an electric motor for driving the pump; and a water gun connected to the pump through a water pipe. The housing is provided with an air inlet and an air outlet, a heat dissipation air path is formed between the air inlet and the air outlet, the heat dissipation air path is located inside the housing, and from the air inlet to the air outlet, the battery holder and the control board are located on the heat dissipation air path in sequence.

In some examples, a power management board disposed in the housing is further included, where the power management board is used for managing a usage state of the battery pack, and from the air inlet to the air outlet, the battery holder, the power management board, and the control board are located on the heat dissipation air path in sequence.

In some examples, two battery packs are provided, and the two battery packs are located on two sides of the power management board, respectively.

In some examples, a cooling fan is disposed on the control board, and from the air inlet to the air outlet, the battery holder, the cooling fan, and the control board are located on the heat dissipation air path in sequence.

In some examples, a top cover is disposed on the top of the housing, the top cover is used for opening or closing the battery holder, and the battery pack is vertically inserted into the battery holder.

In some examples, a partition portion is disposed in the middle of the battery holder, and the partition portion divides the battery holder into two sub-battery holders; two battery packs are provided and located in the two sub-battery holders, respectively, and the interfaces of the two battery packs are opposite to each other and face the partition portion.

In some examples, two battery packs are provided, and the two battery packs are arranged in parallel.

In some examples, the battery pack is located above the electric motor and the pump, and the control board is located in front of the battery pack.

In some examples, an opening of the air inlet faces a lower side of the pressure washer.

In some examples, the air outlet is opened on a left side and/or a right side of the housing.

In some examples, pull rods, pull rod mounting portions, and traveling wheels are further included, where the pull rod mounting portions are disposed on a rear side of the housing, the pull rods are mounted on the pull rod mounting portions, and when the pull rods are pulled, the traveling wheels rotate so that the pressure washer moves.

In some examples, the air inlet is disposed on a bottom side of a pull rod mounting portion, and the opening of the air inlet faces downward.

In some examples, two groups of air outlets are provided and located on the left side and the right side of the housing, respectively.

In some examples, the housing includes a front housing and a rear housing, the front housing is located in front of the rear housing, a gap exists between the rear housing and the pull rods, and the gap forms a storage space for the water pipe.

In some examples, a hose reel for storing the water pipe is disposed on the rear housing, the central axis of the hose reel is basically parallel to the forward direction of the traveling wheels, and the hose reel is rotatable relative to the housing to retract and release the water pipe.

A pressure washer includes a housing formed with a battery holder and a drive compartment; a battery pack accommodated in the battery holder; a control board disposed in the housing; a drive assembly disposed in the drive compartment and including a pump and an electric motor for driving the pump; and a water gun connected to the pump through a water pipe. The battery pack is located above the electric motor and the pump, and the control board is located in front of the battery pack.

In some examples, a power management board disposed in the housing is further included, where the power management board is used for managing a usage state of the battery pack, the housing is provided with an air inlet and an air outlet, a heat dissipation air path is formed between the air inlet and the air outlet, and from the air inlet to the air outlet, the battery holder, the power management board, and the control board are located on the heat dissipation air path in sequence.

In some examples, two battery packs are provided, and the two battery packs are located on two sides of the power management board, respectively.

In some examples, a cooling fan is disposed on the control board, and from the air inlet to the air outlet, the battery holder, the cooling fan, and the control board are located on the heat dissipation air path in sequence.

In some examples, a top cover is disposed on the top of the housing, the top cover is used for opening or closing the battery holder, and the battery pack is vertically inserted into the battery holder.

### BRIEF DESCRIPTION OF THE DRAWINGS

FIG. 1 is a structural view of a pressure washer according to the present application.

FIG. 2 is a structural view of a pressure washer after a front housing and a rear housing are disassembled according to the present application.

FIG. 3 is a structural view of a pressure washer after a top cover and a battery pack are hidden according to the present application.

FIG. 4 is a front view of a pressure washer after a front cover is hidden according to the present application.

FIG. 5 is a structural view of a pressure washer after a front cover and a drive assembly are hidden according to the present application from a first perspective.

FIG. 6 is a structural view of a pressure washer after a front cover and a drive assembly are hidden according to the present application from a second perspective.

FIG. 7 is a partial view of an air inlet of a pressure washer according to the present application.

FIG. 8 is a structural view of a pressure washer with pull rods retracted according to the present application.

FIG. 9 is a structural view of a pressure washer with pull rods extended according to the present application.

FIG. 10 is a front view of a pressure washer according to the present application.

FIG. 11 is a right side view of a pressure washer after a hose reel is hidden according to the present application.

FIG. 12 is a side view of a pressure washer including a hose reel according to the present application.

FIG. 13 is a left side view of a pressure washer according to the present application.

FIG. 14 is an exploded view of a water gun, an upper buttstock, and a lower buttstock that are unassembled according to the present application.

FIG. 15 is an exploded view of a water gun and an upper buttstock that are unassembled according to the present application.

FIG. 16 is an exploded view of a water gun and an upper buttstock that are assembled according to the present application.

FIG. 17 is a structural view of an upper buttstock according to the present application.

FIG. 18 is a structural view of a lower buttstock according to the present application.

FIG. 19 is an exploded view of an upper buttstock, a lower buttstock, and a housing of a pressure washer according to the present application.

FIG. 20 is a structural view of a water gun according to the present application.

FIG. 21 is a structural view of a gun handle according to the present application.

FIG. 22 is a structural view of a shortened water gun according to some examples of the present application.

FIG. 23 is structural view one of a lengthened water gun according to some examples of the present application.

FIG. 24 is structural view two of a lengthened water gun according to some examples of the present application.

FIG. 25 is an exploded view of a locking mechanism according to some examples of the present application.

FIG. 26 is a structural view of a locking mechanism in a locking state according to some examples of the present application.

FIG. 27 is a structural view of a locking mechanism in an unlocking state according to some examples of the present application.

FIG. 28 is a structural view of a shortened water gun according to other examples of the present application.

FIG. 29 is a structural view of a lengthened water gun according to other examples of the present application.

FIG. 30 is a structural view of a locking mechanism in a locking state according to other examples of the present application.

FIG. 31 is a structural view of a locking mechanism in an unlocking state according to other examples of the present application.

FIG. 32 is a schematic diagram of a driver circuit according to an example.

FIG. 33 is a flowchart of a control method for a pressure washer according to some examples of the present application.

FIG. 34 is a flowchart of a control method for a pressure washer according to other examples of the present application.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

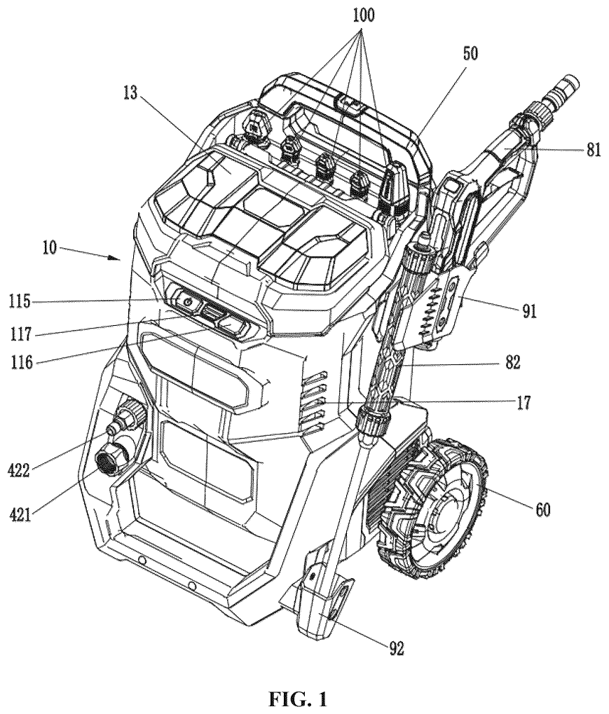

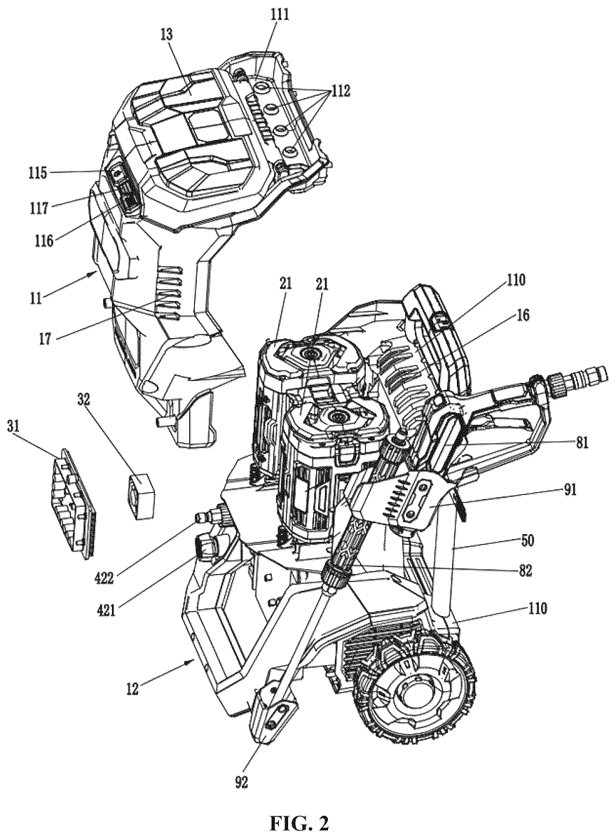

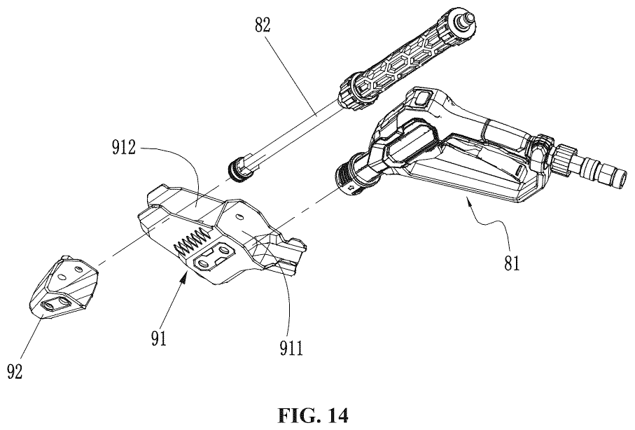

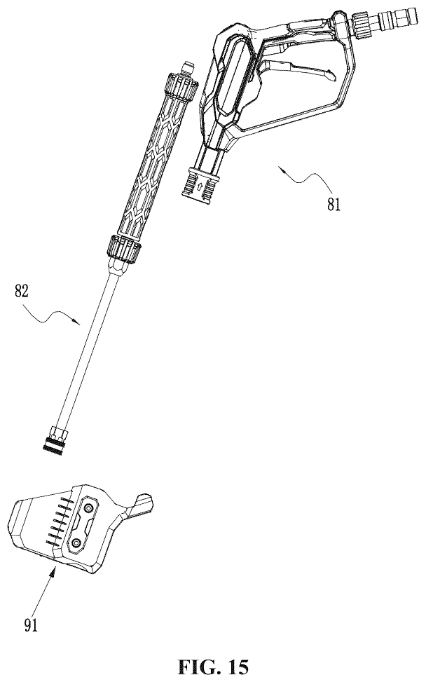

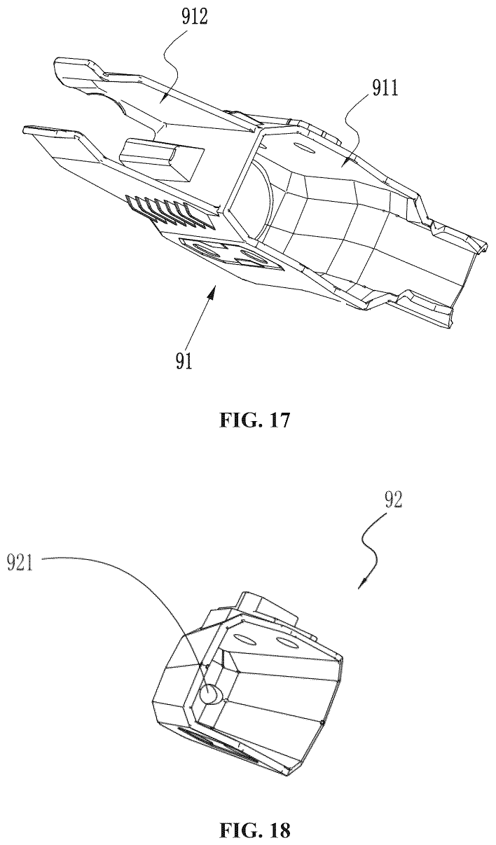

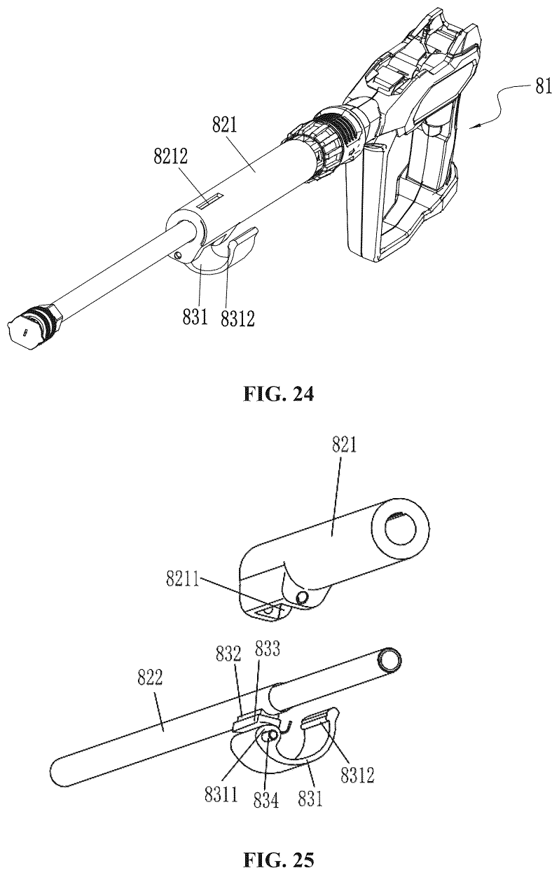

As shown in FIGS. 1 to 31, an example of the present application provides a pressure washer. The pressure washer includes a housing 10, battery packs 21, a drive assembly 40, a control board 31, a power management board 23, a water gun 80, a locking mechanism 83, an upper buttstock 91, and a lower buttstock 92.

Referring to FIGS. 1 to 4, the housing 10 is formed by splicing a front housing 11 and a rear housing 12. The front housing 11 is located on the front side of the rear housing 12. A battery holder 14 and a drive compartment 15 are formed in the housing 10. The battery packs 21 are accommodated in the battery holder 14, and the drive assembly 40 is accommodated in the drive compartment 15. The drive assembly 40 includes an electric motor 41 and a pump 42. The battery packs 21 are used for supplying power to the electric motor 41. The electric motor 41 drives the pump 42 through a transmission assembly 43. The pump 42 is connected to the water gun 80 through a water pipe 72. The electric motor 41 drives the pump 42 to generate high pressure water, and the high pressure water is sprayed out by the water gun 80 to clean the surface of an object.

Two battery packs 21 are provided, and the two battery packs 21 are arranged in parallel. The two battery packs 21 are arranged in parallel, thereby extending the battery life. The output voltage of a single battery pack 21 is greater than or equal to 36 V. In an example, the output voltage of the battery pack 21 may be 40 V or 56 V. The two battery packs 21 form a battery pack group, and the maximum output power of the battery pack group is greater than or equal to 1500 W. In some examples, the maximum output power of the battery pack group is greater than or equal to 1800 W. In some examples, the maximum output power of the battery pack group may be 1700 W, 1800 W, 2000 W, 2100 W, 2200 W, or 2300 W. The maximum water pressure that the water gun 80 can provide is greater than or equal to 2500 PSI. In some examples, the maximum water pressure of the water gun 80 may be 2500 PSI, 2700 PSI, 3000 PSI, 3100 PSI, 3200 PSI, or 3300 PSI.

In a specific example, the pressure washer uses two 56 V battery packs 21 arranged in parallel. When the flow rate of the water gun 80 is 1.2 GPM, the maximum water pressure of the water gun 80 may reach 3200 PSI. At this time, the maximum output power of the battery packs is about 2100 W.

A partition portion 141 is disposed in the middle of the battery holder 14, and the partition portion 141 divides the battery holder 14 into two sub-battery holders 14. The two battery packs 21 are located in the two sub-battery holders 14, respectively, and the interfaces of the two battery packs 21 are opposite to each other and face the partition portion 141. A pole piece 22 is disposed on each of two side surfaces of the partition portion 141 facing the two sub-battery holders 14, and two pole pieces 22 are in one-to-one correspondence with the two battery packs 21. Two battery pack unlock buttons 1411 are disposed at the upper end of the partition portion 141, and the two battery pack unlock buttons 1411 control the unlocking of the two battery packs 21, respectively. When the battery packs 21 are placed in the battery holder 14, the battery packs 21 are locked, and at this time, the battery packs 21 cannot be taken out of the battery holder 14. When the battery pack unlock buttons 1411 are pressed, the battery packs 21 are unlocked, and at this time, the battery packs 21 can be taken out of the battery holder 14. A top cover 13 is disposed on the top of the housing 10, and the top cover 13 is used for opening and closing the battery holder 14. The opening of the battery holder 14 faces upward, and the battery packs 21 are vertically inserted into the battery holder 14.

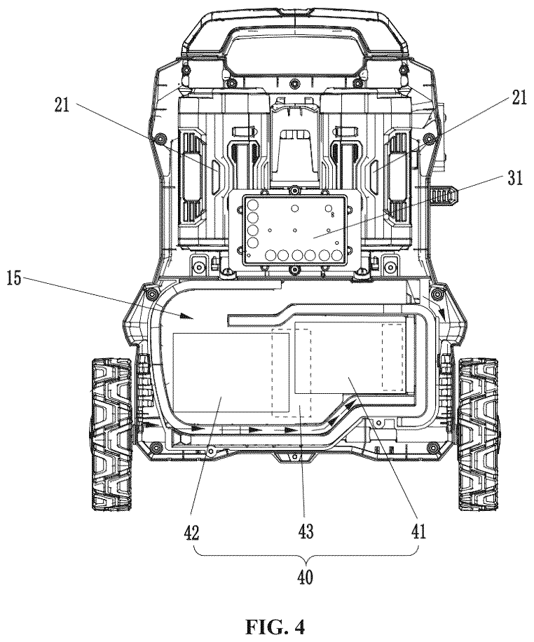

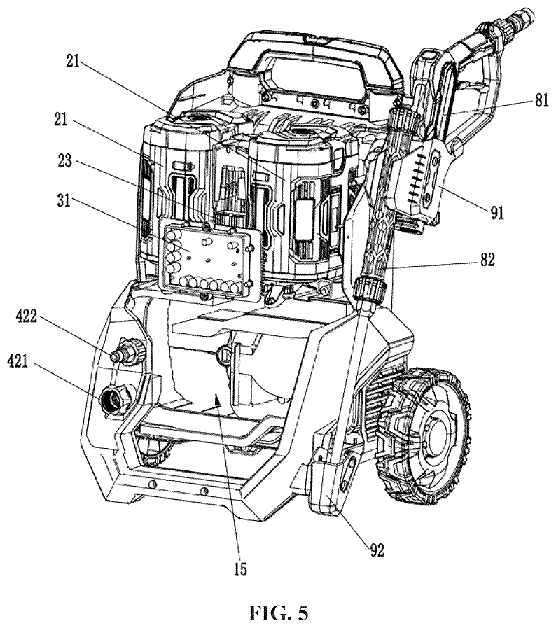

Referring to FIGS. 4 and 5, the battery packs 21 are located above the electric motor 41 and the pump 42. The control board 31 is located in front of the battery packs 21. A cooling fan 32 is disposed on the control board 31. The cooling fan 32 can dissipate heat for the control board 31. The power management board 23 is located between the two battery packs 21. The power management board 23 is used for managing the usage state of the battery packs 21, for example, determining the discharge sequence of the two battery packs 21, monitoring the power of the battery packs 21, and the like.

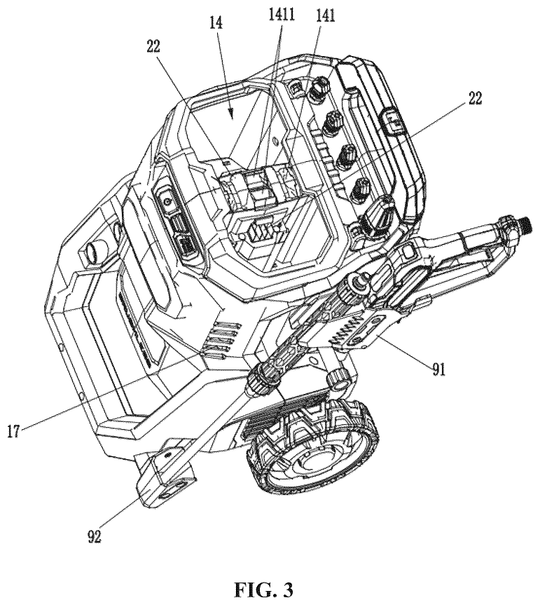

Referring to FIGS. 3 to 7, the housing 10 has a heat dissipation air path for dissipating heat for the battery packs 21. The housing 10 is provided with an air inlet 16 and an air outlet 17, the heat dissipation air path is formed between the air inlet 16 and the air outlet 17, and the heat dissipation air path is located inside the housing 10. In some examples, from the air inlet 16 to the air outlet 17, the battery holder 14 and the control board 31 are located on the heat dissipation air path in sequence, that is, the heat dissipation air path can dissipate heat for the battery holder 14 and the control board 31 at the same time. In some examples, from the air inlet 16 to the air outlet 17, the battery holder 14, the cooling fan 32, and the control board 31 are located on the heat dissipation air path in sequence, that is, the heat dissipation air path can dissipate heat for the battery holder 14, the cooling fan 32, and the control board 31 at the same time. In some examples, from the air inlet 16 to the air outlet 17, the battery holder 14, the power management board 23, and the control board 31 are located on the heat dissipation air path in sequence, that is, the heat dissipation air path can dissipate heat for the battery holder 14, the power management board 23, and the control board 31 at the same time. In the preceding examples, the heat dissipation air path can not only pass through the battery holder 14 but also pass through the control board 31, that is, not only does the cooling fan 32 on the control board 31 dissipate heat for the control board 31, but also the heat dissipation air path dissipates heat for the control board 31 at the same time, so the heat dissipation effect is good.

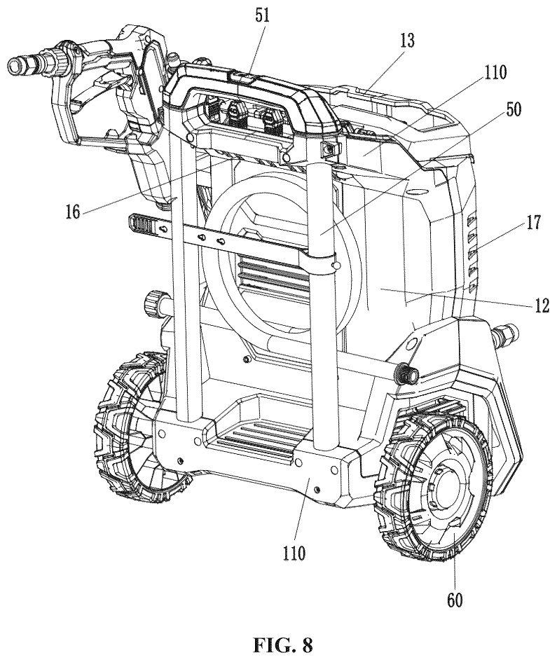

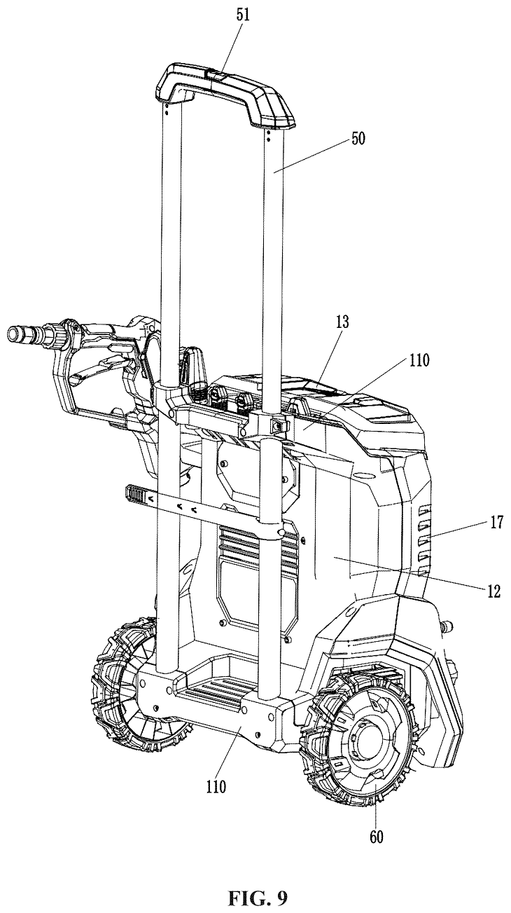

Referring to FIGS. 8 and 9, at least two pull rod mounting portions 110 are disposed on the rear side of the housing 10, and the two pull rod mounting portions 110 are spaced apart along the height direction of the housing 10. Pull rods 50 are mounted on the pull rod mounting portions 110. Traveling wheels 60 are disposed at the bottom of the housing 10. The pull rods 50 are used for pulling the whole machine to move, thereby facilitating the movement of the whole machine. In some examples, the pull rods 50 are telescopic rods. When the pressure washer needs to be pulled to move, the pull rods 50 are extended to a state shown in FIG. 9; and when the pressure washer reaches a target position, the pull rods 50 are retracted to a state shown in FIG. 8. The pull rods 50 are provided with a pull rod unlock button 51. By pressing the pull rod unlock button 51, the pull rods 50 can be extended or retracted. By releasing the pull rod unlock button 51, the pull rods 50 are locked.

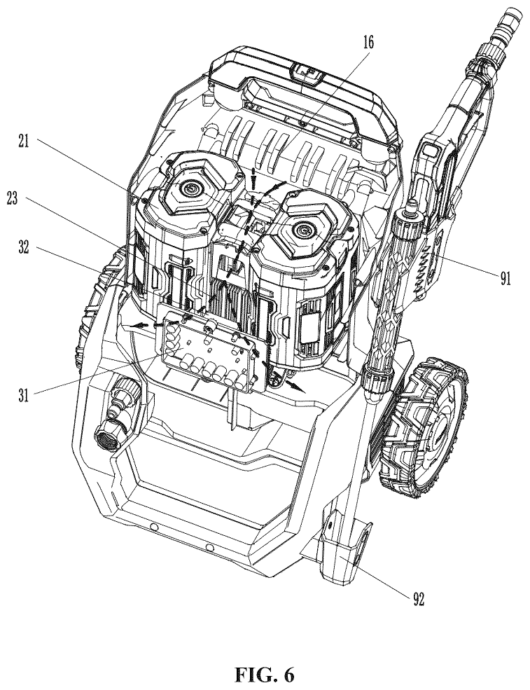

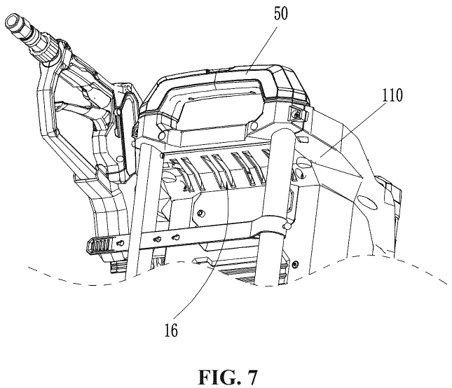

Referring to FIG. 8 and in conjunction with FIGS. 6 and 7, the air inlet 16 is disposed on the bottom side of the pull rod mounting portion 110 located on the upper rear side of the housing 10, and the opening of the air inlet 16 faces downward so that the air inlet 16 at this position can be shielded, thereby achieving a waterproof effect for the air inlet 16. Referring to FIGS. 8 to 10, in some examples, one group of air outlets 17 are provided and located on the left side or the right side of the housing 10. In some examples, two groups of air outlets 17 are provided and located on the left side and the right side of the housing 10, respectively.

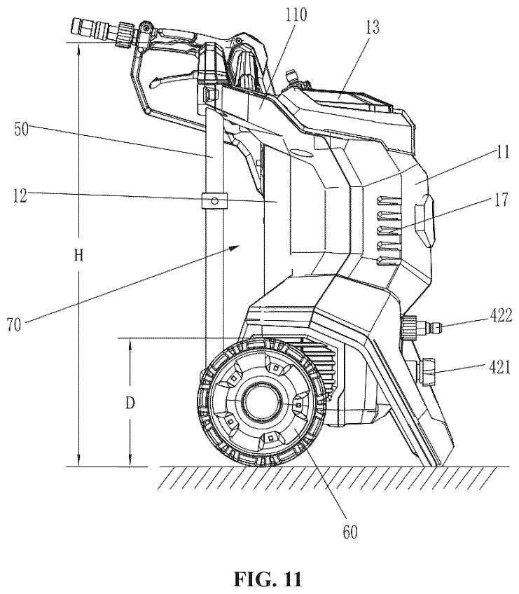

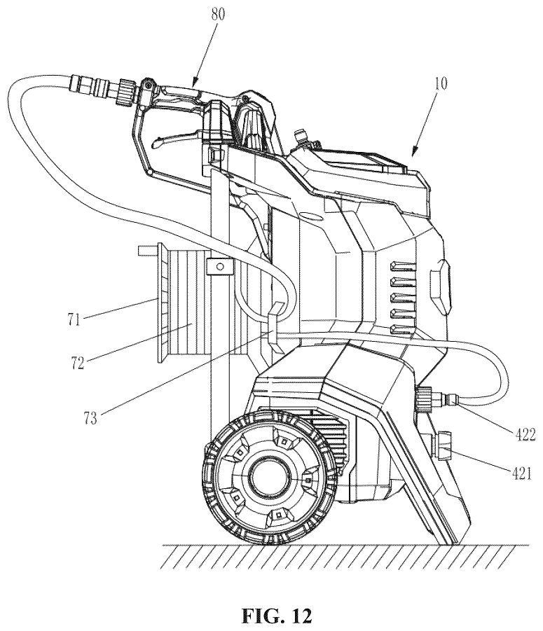

Referring to FIGS. 11 and 12, a gap exists between the rear housing 12 and the pull rods 50, and the gap forms a storage space 70 for the water pipe. A hose reel 71 for storing the water pipe is disposed on the rear housing 12, the central axis of the hose reel 71 is basically parallel to the forward direction of the traveling wheels 60, the water pipe 72 connecting the pump 42 to the water gun 80 is wound on the hose reel 71, and the hose reel 71 is rotatable relative to the housing 10 to retract and release the water pipe 72. In addition, a water pipe guide portion 73 is disposed on the housing 10 and used for guiding the direction of the water pipe 72. At least two guide holes are provided on the water pipe guide portion 73. An end of the water pipe 72 is connected to a water outlet joint 422 of the pump 42; and the other end of the water pipe 72 passes through one of the guide holes, is wound on the hose reel 71, passes through the other guide hole, and is connected to the water gun 80. A water inlet joint 421 of the pump 42 is connected to a water source.

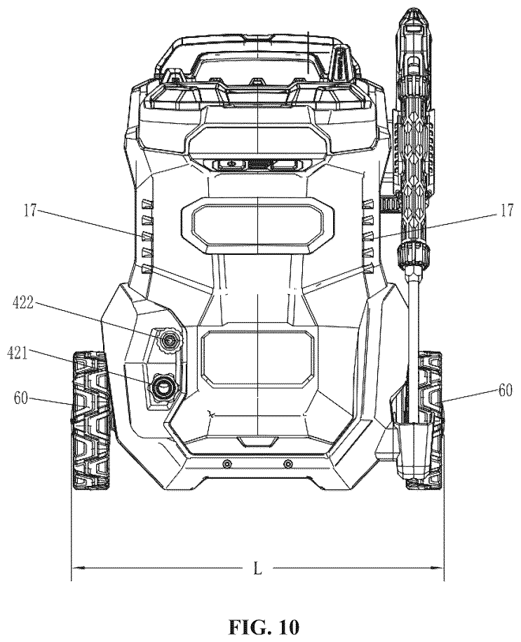

Referring to FIGS. 10 and 11, the height of the traveling wheel 60 is D, the height of the whole machine when the pull rods 50 are not pulled out is H, and the distance between the outer end surfaces of two traveling wheels 60 is L. In some examples, D/H is greater than or equal to 25%. In some examples, D/H is greater than or equal to 28%. In some examples, D/H is greater than or equal to 30%. In this manner, the wheels are larger and the machine is easier to control. In some examples, H is about 60 cm, L is about 48 cm, and D is about 18 cm.

The water gun 80 includes a gun handle 81 and a gun shaft 82 that are detachably connected. The water gun 80 is used in two manners. In one manner, the gun handle 81 is not connected to the gun shaft 82, and the gun handle 81 is directly connected to a nozzle 100, that is, the water gun 80 may be used as a short gun. In the other manner, the gun handle 81 and the gun shaft 82 are assembled and then the gun shaft 82 is connected to the nozzle 100, that is, the water gun 80 may be used as a long gun. The short gun may be equipped with a special nozzle for direct water washing, and the long gun may be equipped with a high pressure nozzle for high pressure washing. Referring to FIGS. 1 to 3, the nozzle 100 has various models. To facilitate the removal and placement of the nozzle 100, a nozzle receiving seat 111 is disposed on the pull rod mounting portion 110 located on the upper rear side of the housing 10, multiple receiving holes 112 are provided on the nozzle receiving seat 111, and nozzles 100 of different models can be placed in corresponding receiving holes 112. Nozzles 100 of different models may be set to different colors, thereby facilitating user identification and providing a good visualization effect.

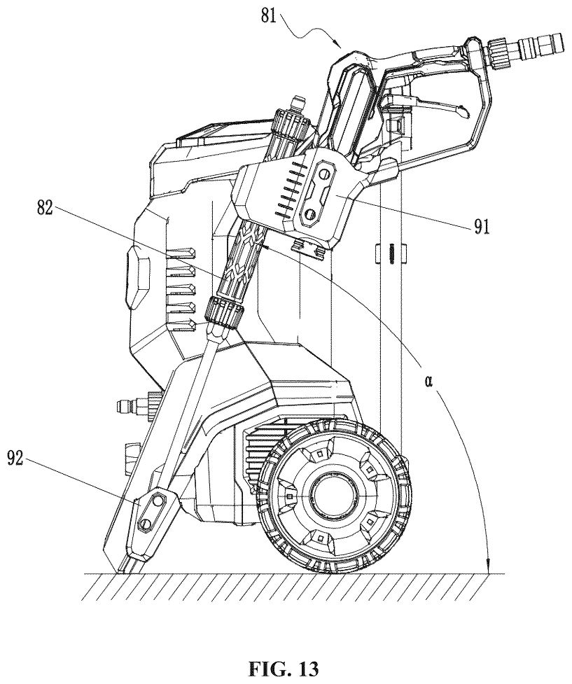

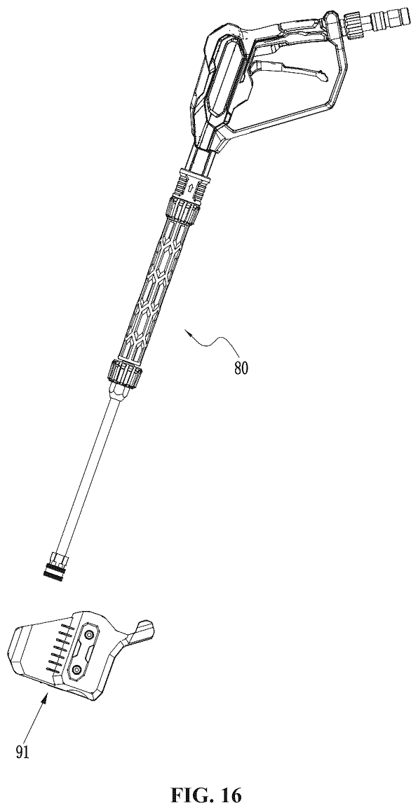

Referring to FIGS. 13 to 19, the upper buttstock 91 and the lower buttstock 92 are disposed on the housing 10, where the upper buttstock 91 is provided with a first mounting groove 911 and a second mounting groove 912. The gun handle 81 that is not assembled with the gun shaft 82 can be mounted in the first mounting groove 911, the gun shaft 82 that is not assembled with the gun handle 81 can be mounted in the second mounting groove 912, and the entire water gun 80 after the gun handle 81 and the gun shaft 82 are assembled can be mounted in the second mounting groove 912. The lower buttstock 92 is used for supporting the lower end of the gun shaft 82, and the lower buttstock 92 can accommodate the end of the gun shaft 82 without removing the nozzle 100. A water leakage hole 921 is provided at the bottom of the lower buttstock 92, and the residual water in the water gun 80 can flow out from the water leakage hole 921. That is, the water gun 80 is stored in two manners. In one manner, as shown in FIGS. 13 to 15, the gun shaft 82 and the gun handle 81 are not assembled, the gun shaft 82 is mounted in the second mounting groove 912 of the upper buttstock 91 and the lower buttstock 92, and the gun handle 81 is mounted in the first mounting groove 911 of the upper buttstock 91. In the other manner, as shown in FIG. 16, the gun shaft 82 and the gun handle 81 are assembled into the entire water gun 80, the assembled water gun 80 is mounted as a whole in the second mounting groove 912 of the upper buttstock 91 and the lower buttstock 92, and in this manner, the first mounting groove 911 of the upper buttstock 91 is vacant.

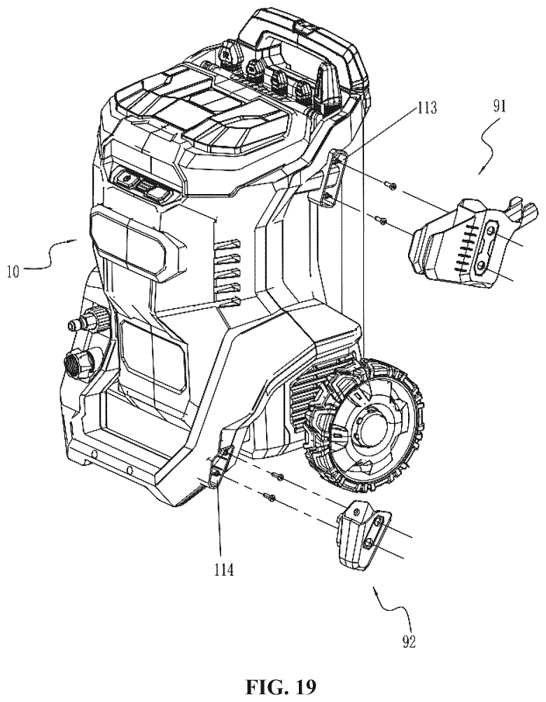

The upper buttstock 91 and the housing 10 are detachably connected; and/or the lower buttstock 92 and the housing 10 are detachably connected. In some examples, the upper buttstock 91 is connected to the housing 10 via screws; and/or the lower buttstock 92 is connected to the housing 10 via screws. Specifically, referring to FIG. 19, the housing 10 has an upper mounting portion 113 and a lower mounting portion 114, the upper buttstock 91 is mounted to the upper mounting portion 113 via the screws, and the lower buttstock 92 is mounted to the lower mounting portion 114 via the screws. In some examples, the upper mounting portion 113 and the lower mounting portion 114 are disposed on each of two sides of the housing 10 along the left and right direction, and the upper buttstock 91 and the lower buttstock 92 may be connected to the upper mounting portion 113 and the lower mounting portion 114 on the left side or may be connected to the upper mounting portion 113 and the lower mounting portion 114 on the right side. In some examples, the upper mounting portion 113 and the lower mounting portion 114 are disposed on each of two sides of the housing 10 along the left and right direction, the upper mounting portion 113 and the lower mounting portion 114 on the left side are connected to the upper buttstock 91 and the lower buttstock 92, and the upper mounting portion 113 and the lower mounting portion 114 on the right side are also connected to the upper buttstock 91 and the lower buttstock 92. In this manner, the water gun 80 may be stored on the left side of the housing 10 or the right side of the housing 10, thereby satisfying different usage requirements of the user.

When the gun shaft 82 is mounted to the upper buttstock 91 and the lower buttstock 92, the gun shaft 82 is disposed at an included angle α with the ground. In some examples, the included angle α is 45 degrees to 80 degrees. In some examples, the included angle α is 60 degrees to 75 degrees. For example, the included angle α may be 60 degrees, 65 degrees, 70 degrees, or 75 degrees.

In addition, in some examples, the water gun 80 may be stored horizontally on the upper side of the housing 10. The housing 10 is provided with a groove on the rear side of the top cover 13 of the battery holder 14, and the water gun 80 may be fixed through the groove.

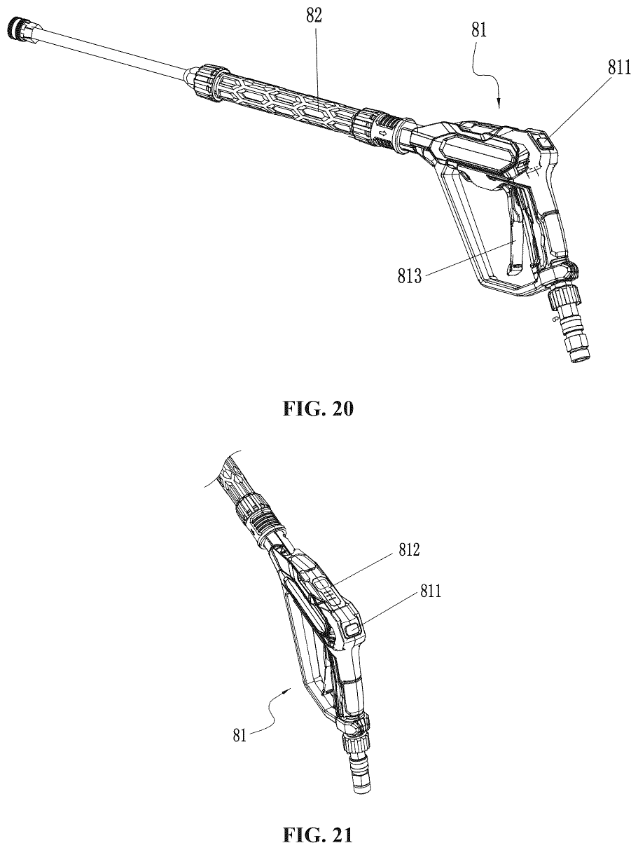

Referring to FIGS. 20 and 21, the gun handle 81 has a trigger 813, and the water gun 80 can be turned on and off by the trigger 813.

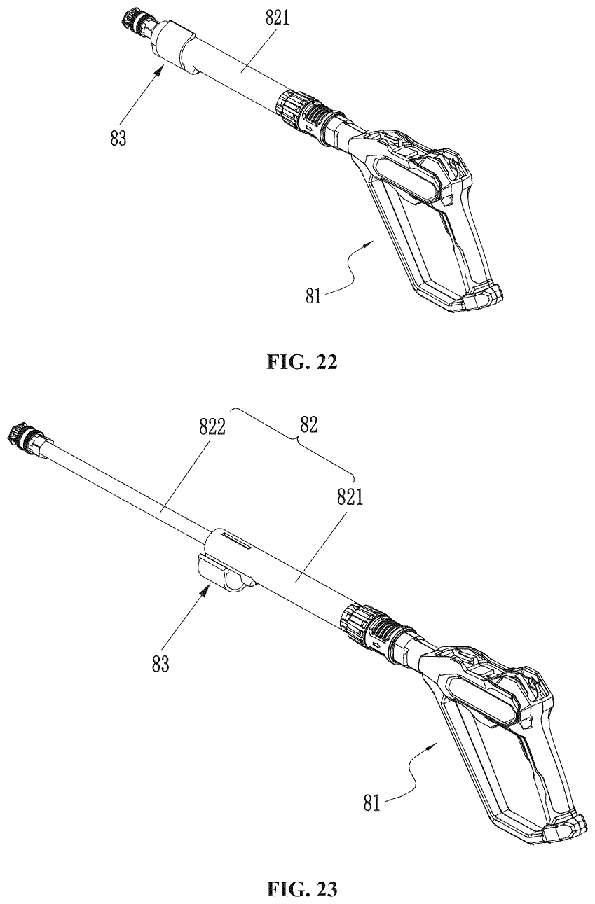

Referring to FIGS. 22 to 31, the gun shaft 82 is a telescopic rod. The gun shaft 82 is telescopic so that the length of the gun shaft 82 is changeable. The gun shaft 82 includes an inner tube 823, an outer tube 822, and a gun barrel 821. The outer tube 822 is sleeved on the outer side of the inner tube 823, and the gun barrel 821 is sleeved on the outer side of the outer tube 822. The outer tube 822 can extend or retract relative to the inner tube 823 and the gun barrel 821. The locking mechanism 83 is configured to achieve locking and unlocking of the outer tube 822 by changing the friction between the locking mechanism 83 and the outer tube 822. Alternatively, the locking mechanism 83 is configured to be capable of locking the outer tube 822 to any position.

Specifically, the locking mechanism 83 includes an elastic member and a driving member, and the driving member can drive the elastic member to compress or loosen the outer tube 822 along the radial direction of the outer tube 822 to increase or reduce the friction between the elastic member and the outer tube 822, thereby achieving locking or unlocking of the outer tube 822.

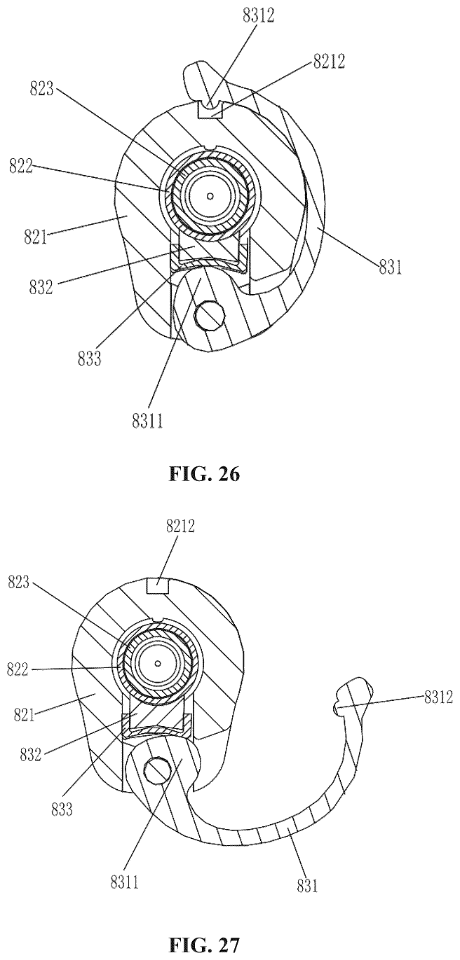

In some examples, referring to FIGS. 22 to 27, the driving member is a trigger 831 rotatably connected to the gun barrel 821 via a rotary shaft, the axis of the rotary shaft is parallel to the axis of the gun barrel 821, a driving protrusion 8311 is formed at an end of the trigger 831, the gun barrel 821 is provided with an accommodation groove 8211 connecting with a center hole of the gun barrel 821, the elastic member is an elastic block 832, the elastic block 832 is movably disposed in the accommodation groove 8211, and a rigid seat 833 may also be disposed in the accommodation groove 8211 so that part of the elastic block 832 is accommodated in the rigid seat 833. The driving protrusion 8311 is at least partially located in the accommodation groove 8211. The driving protrusion 8311 can support the rigid seat 833. The profile of the driving protrusion 8311 is configured such that the driving protrusion 8311 can drive the elastic block 832 to compress or loosen the outer tube 822 when the trigger 831 rotates. Specifically, the profile of the driving protrusion 8311 is spiral. Referring to FIGS. 22 and 26, the trigger 831 rotates in a first direction, and the spiral driving protrusion 8311 gradually lifts the rigid seat 833 and the elastic block 832 as the trigger 831 moves so that the elastic block 832 presses against the outer tube 822 and deforms to lock the outer tube 822. Referring to FIGS. 23, 24, and 27, the trigger 831 rotates in a second direction, the spiral driving protrusion 8311 deviates from the rigid seat 833 and the elastic block 832 as the trigger 831 moves, the elastic block 832 is separated from the outer tube 822, the state in which the elastic block 832 locks the outer tube 822 is released, and the outer tube 822 is unlocked.

The trigger 831 is C-shaped. A locking protrusion 8312 is provided at the other end of the trigger 831, a locking groove 8212 is provided on the gun barrel 821, and the locking protrusion 8312 can engage with the locking groove 8212 so that the trigger 831 is fixed in a locked state. When the trigger 831 rotates in the first direction to a position where the elastic member locks the outer tube 822, the locking protrusion 8312 can engage with the locking groove 8212 so that the trigger 831 is kept in the locked state.

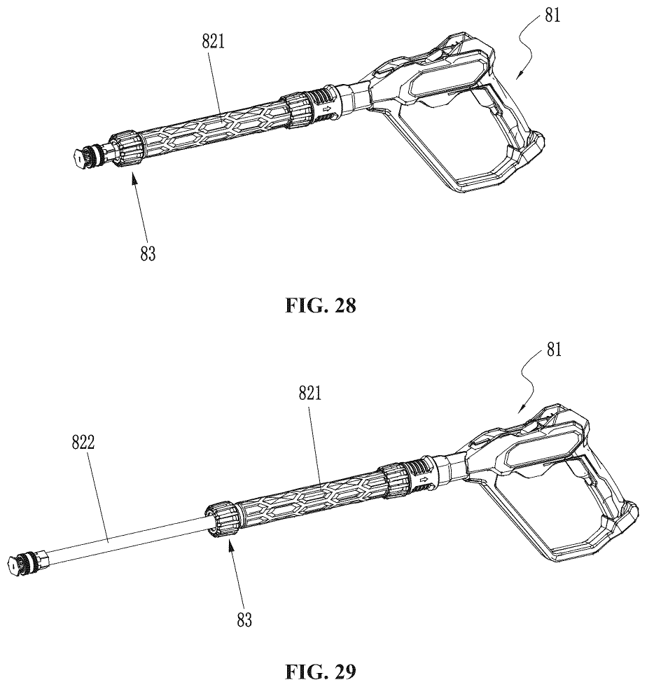

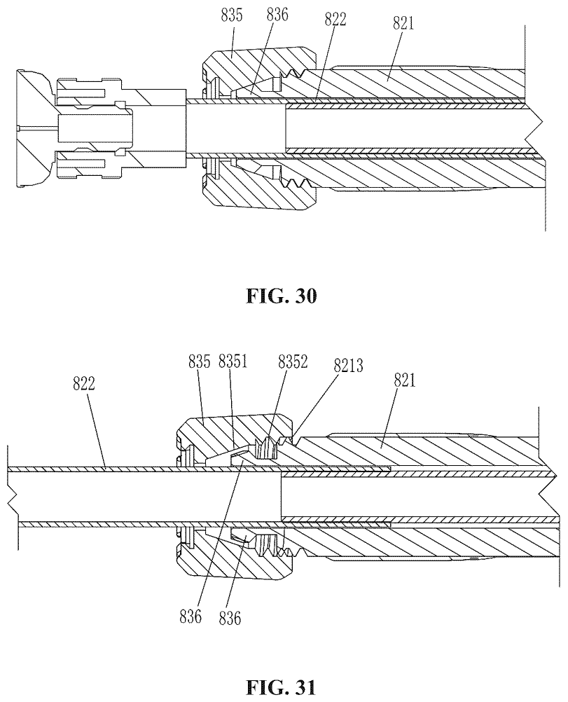

In some examples, referring to FIGS. 28 to 31, the driving member is a rotary sleeve 835, the inner surface of the rotary sleeve 835 includes a first conical surface 8351, internal threads 8352 are provided on the inner surface of the rotary sleeve 835 close to the large-end side of the conical surface, the elastic member is disposed at the end of the gun barrel 821, external threads 8213 are provided at the end of the gun barrel 821, and the rotary sleeve 835 is threadedly connected to the gun barrel 821. When the rotary sleeve 835 rotates, the conical surface can drive the elastic member to compress or loosen the outer tube 822. Referring to FIGS. 28 and 30, the rotary sleeve 835 rotates in the direction in which the rotary sleeve 835 and the external threads 8213 of the gun barrel 821 are tightened, and the first conical surface 8351 in the rotary sleeve 835 causes the elastic member to deform and lock the outer tube 822. Referring to FIGS. 29 and 31, the rotary sleeve 835 rotates in the direction in which the rotary sleeve 835 and the external threads 8213 of the gun barrel 821 are loosened, the elastic member is reset, the state in which the elastic member locks the outer tube 822 is released, and the outer tube 822 is unlocked.

The elastic member includes multiple elastic arms 836 arranged at intervals along the circumferential direction of the outer tube 822. The outer wall surface of the elastic arms 836 includes a second conical surface, and the second conical surface of the elastic arms 836 fits the first conical surface 8351 of the rotary sleeve 835.

The locking mechanism 83 provided in the preceding examples achieves the stepless adjustment of the telescopic length of the water gun 80, the structure of the locking mechanism 83 is simple, and the requirements for the accuracy of machining, manufacturing, and mutual coordination are relatively low; the structural form of the locking mechanism 83 determines that looseness of the outer tube 822 does not exist and an adjustable damping feel is provided; and the structural form of the locking mechanism 83 determines that locking and unlocking do not require a twisting action, thereby ensuring the life of the inner tube 823.

The battery packs 21, the drive assembly 40, and the like disposed in the housing 10 and the housing 10 together form the body. Referring to FIG. 1, the housing 10 of the body is provided with a switch button 115, a first speed regulation button 116, and a first display portion 117. The switch button 115 is used for starting and shutting down the body, the first speed regulation button 116 is used for switching gears, and the first display portion 117 is used for displaying the current gear.

Synchronous control of the gear adjustment and light display states is achieved through 2.4 G wireless pairing of the body and the water gun 80. Referring to FIG. 21, the water gun 80 is provided with a second speed regulation button 811 and a second display portion 812. After the body is powered on, the water gun 80 may be controlled via the 2.4 G wireless, and the second speed regulation button 811 is operated to switch gears. The second display portion 812 can display the current gear and can also display the power of the battery in the water gun 80 or the power of the battery packs 21 of the body.

The gears of the pressure washer include the first working gear, the second working gear, and the third working gear. The first working gear corresponds to the first output power, and the first output power is relatively low. After the first working gear is selected, the machine continues working until the machine is turned off. The second working gear corresponds to the second output power, and the second output power is relatively large. After the second working gear is selected, the machine continues working until the machine is turned off. The third working gear corresponds to the third output power, and the third output power is the maximum and can provide the maximum pressure. After the third working gear is selected, the machine is automatically turned off after working for a preset period (such as 30s).

After the pressure washer is powered on, the gear is selected, and then the pressure washer works according to the selected gear. To achieve high-efficiency discharge of the battery packs 21, the present application further provides a control method for the pressure washer. To perform the control method, the electric motor 41 is a brushless direct current electric motor (BLDC), and the electric motor 41 includes a rotor and multiple phases of stator windings. In addition, the pressure washer further includes a power module 400, a driver circuit 300, and a control module 200. The power module 400 is used for supplying electrical energy, and the power module includes the preceding battery packs 21. The driver circuit 300 is electrically connected to the electric motor 41 and the power module 400 and is used for loading the electrical signal provided by the power module to the electric motor 41. The control module 200 is used for outputting a pulse width modulation signal to control the driver circuit 300.

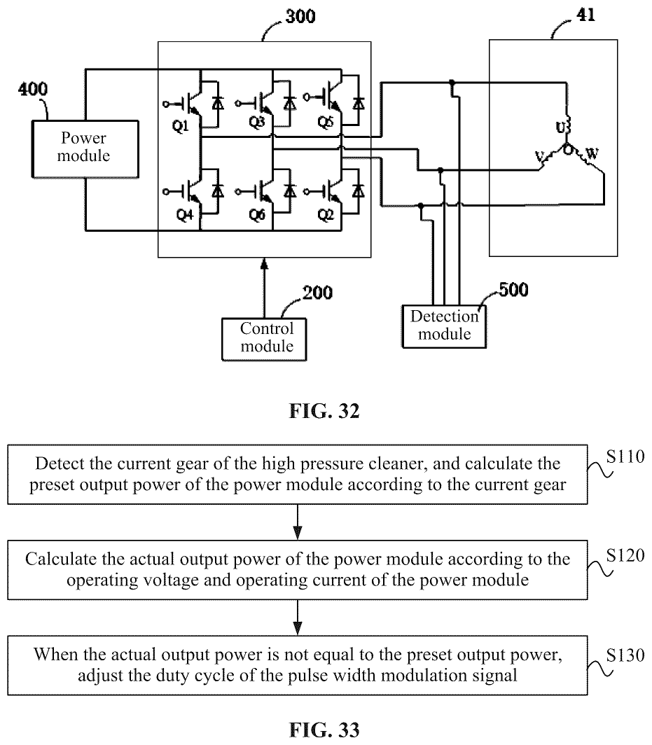

As an example, as shown in FIG. 32, the driver circuit 300 includes multiple switching elements Q1, Q2, Q3, Q4, Q5, and Q6. Each gate terminal of the switching elements is electrically connected to the control module 200 and is used for receiving the control signal from the control module 200. Drains or sources of the switching elements are connected to the stator windings of the electric motor 41. The switching elements Q1 to Q6 receive the control signals from the control module 200 to change respective on states, thereby changing the current loaded to the stator windings of the electric motor 41 by the power module 400. In an example, the driver circuit 300 may be a three-phase bridge driver circuit including six controllable semiconductor power devices (such as field-effect transistors (FETs), bipolar junction transistors (BJTs), or insulated-gate bipolar transistors (IGBTs)). It is to be understood that the preceding switching elements may be any other types of solid-state switches, such as the IGBTs or the BJTs. The pressure washer further includes a detection module 500 for detecting the operating voltage and operating current of the power module 400.

The control module 200 is configured to acquire the current gear of the pressure washer, and calculate the preset output power of the power module 400 according to the current gear; calculate the actual output power of the power module 400 according to the operating voltage and operating current of the power module 400; and when the actual output power is not equal to the preset output power, adjust the duty cycle of the pulse width modulation signal to keep the actual output power of the power module 400 basically equal to the preset output power.

Specifically, the control module is configured to increase the duty cycle of the pulse width modulation signal when the actual output power of the battery packs is less than the preset output power and reduce the duty cycle of the pulse width modulation signal when the actual output power of the battery packs 21 is greater than the preset output power.

A flowchart of a control method for a pressure washer is described below in conjunction with FIG. 33, and the method includes the steps below.

In S110, the current gear of the pressure washer is acquired, and the preset output power of the power module 400 is calculated according to the current gear.

In S120, the actual output power of the power module 400 is calculated according to the operating voltage and operating current of the power module.

In S130, when the actual output power is not equal to the preset output power, the duty cycle of the pulse width modulation signal is adjusted to keep the actual output power of the power module 400 basically equal to the preset output power.

Specifically, when it is detected that the actual output power of the battery packs 21 is less than the preset output power, the duty cycle of the pulse width modulation signal is increased. Generally, two cases where the actual output power of the battery packs 21 decreases exist. In one case, when the battery packs 21 are used for a longer time, the voltage of the battery pack 21 decreases, causing the current of the electric motor 41 to decrease. In this case, the rotational speed of the electric motor 41 decreases, and then the pressure and flow rate of the pump 42 decrease. At this time, the duty cycle of the pulse width modulation signal is increased to increase the output current of the battery pack 21, thereby keeping the output power of the battery packs 21 constant and indirectly increasing the rotational speed of the electric motor 41. In this manner, the pressure and flow rate of the pump 42 are stabilized within a certain range. In the other case, when the diameter of the nozzle 100 switches from small to large, the flow rate increases and the pressure decreases. To improve the pressure and match the flow rate, the rotational speed of the electric motor 41 is controlled to increase. At this time, the output current of the battery pack 21 does not satisfy the requirements. At this time, the duty cycle of the pulse width modulation signal is increased to increase the output current of the battery pack 21, thereby indirectly increasing the rotational speed of the electric motor 41. In this manner, the pressure and flow rate of the pump 42 match the diameter of the nozzle 100 at this time.

When it is detected that the actual output power of the battery packs 21 is greater than the preset output power, the duty cycle of the pulse width modulation signal is reduced. Generally, one case where the actual output power of the battery packs 21 increases exists. In this case, when the diameter of the nozzle 100 switches from large to small, the flow rate decreases and the pressure increases. To reduce the pressure and match the flow rate, the rotational speed of the electric motor 41 is controlled to decrease, resulting in excessive output current of the battery pack 21. At this time, the duty cycle of the pulse width modulation signal is reduced to reduce the output current of the battery pack 21, thereby indirectly decreasing the rotational speed of the electric motor 41. In this manner, the pressure and flow rate of the pump 42 are stable and match the diameter of the nozzle 100 at this time.

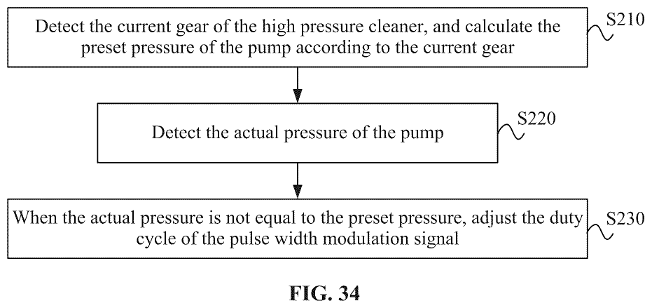

A flowchart of a control method for a pressure washer is described below in conjunction with FIG. 34, and the method includes the steps below.

In S210, the current gear of the pressure washer is detected, and the preset pressure of the pump 42 is calculated according to the current gear.

In S220, the actual pressure of the pump 42 is detected.

In S230, when the actual pressure is not equal to the preset pressure, the duty cycle of the pulse width modulation signal is adjusted to keep the actual pressure of the pump 42 basically equal to the preset pressure.

Specifically, when it is detected that the actual pressure of the pump 42 is less than the preset pressure, the duty cycle of the pulse width modulation signal is increased. Generally, two cases where the pressure of the pump 42 decreases exist. In one case, the battery packs 21 are used for a longer time and the power is reduced; and in the other case, the diameter of the nozzle 100 switches from small to large, and the water pressure decreases while the water flow remains unchanged.

When it is detected that the actual pressure of the pump 42 is greater than the preset pressure, the duty cycle of the pulse width modulation signal is reduced. Generally, one case where the pressure of the pump 42 increases exists. In this case, the diameter of the nozzle 100 switches from large to small.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A pressure washer, comprising:
a housing formed with a battery holder and a drive compartment;
a battery pack accommodated in the battery holder;
a control board disposed in the housing;
a drive assembly disposed in the drive compartment and comprising a pump and an electric motor for driving the pump; and
a water gun connected to the pump through a water pipe;
wherein the housing is provided with an air inlet and an air outlet, a heat dissipation air path is formed between the air inlet and the air outlet, the heat dissipation air path is located inside the housing, and from the air inlet to the air outlet, the battery holder and the control board are located on the heat dissipation air path in sequence.

2. The pressure washer of claim 1, further comprising a power management board disposed in the housing, wherein the power management board is used for managing a usage state of the battery pack, and from the air inlet to the air outlet, the battery holder, the power management board, and the control board are located on the heat dissipation air path in sequence.

3. The pressure washer of claim 2, wherein two battery packs are provided, and the two battery packs are located on two sides of the power management board, respectively.

4. The pressure washer of claim 1, wherein a cooling fan is disposed on the control board, and from the air inlet to the air outlet, the battery holder, the cooling fan, and the control board are located on the heat dissipation air path in sequence.

5. The pressure washer of claim 1, wherein a top cover is disposed on a top of the housing, the top cover is used for opening or closing the battery holder, and the battery pack is vertically inserted into the battery holder.

6. The pressure washer of claim 1, wherein a partition portion is disposed in a middle of the battery holder, the partition portion divides the battery holder into two sub-battery holders, two battery packs are provided and located in the two sub-battery holders, respectively, and interfaces of the two battery packs are opposite to each other and face the partition portion.

7. The pressure washer of claim 1, wherein two battery packs are provided, and the two battery packs are arranged in parallel.

8. The pressure washer of claim 1, wherein the battery pack is located above the electric motor and the pump, and the control board is located in front of the battery pack.

9. The pressure washer of claim 1, wherein an opening of the air inlet faces a lower side of the pressure washer.

10. The pressure washer of claim 1, wherein the air outlet is opened on a left side or a right side of the housing.

11. The pressure washer of claim 9, further comprising pull rods, pull rod mounting portions, and traveling wheels, wherein the pull rod mounting portions are disposed on a rear side of the housing, the pull rods are mounted on the pull rod mounting portions, and, when the pull rods are pulled, the traveling wheels rotate so that the pressure washer moves.

12. The pressure washer of claim 11, wherein the air inlet is disposed on a bottom side of a pull rod mounting portion of the pull rod mounting portions, and the opening of the air inlet faces downward.

13. The pressure washer of claim 10, wherein two groups of air outlets are provided and located on the left side and the right side of the housing, respectively.

14. The pressure washer of claim 11, wherein the housing comprises a front housing and a rear housing, the front housing is located in front of the rear housing, a gap exists between the rear housing and the pull rods, and the gap forms a storage space for the water pipe.

15. The pressure washer of claim 14, wherein a hose reel for storing the water pipe is disposed on the rear housing, a central axis of the hose reel is basically parallel to a forward direction of the traveling wheels, and the hose reel is rotatable relative to the housing to retract and release the water pipe.

16. A pressure washer, comprising:
a housing formed with a battery holder and a drive compartment;
a battery pack accommodated in the battery holder;
a control board disposed in the housing;
a drive assembly disposed in the drive compartment and comprising a pump and an electric motor for driving the pump; and
a water gun connected to the pump through a water pipe;
wherein the battery pack is located above the electric motor and the pump, and the control board is located in front of the battery pack.

17. The pressure washer of claim 16, further comprising a power management board disposed in the housing, wherein the power management board is used for managing a usage state of the battery pack, the housing is provided with an air inlet and an air outlet, a heat dissipation air path is formed between the air inlet and the air outlet, and from the air inlet to the air outlet, the battery holder, the power management board, and the control board are located on the heat dissipation air path in sequence.

18. The pressure washer of claim 17, wherein two battery packs are provided, and the two battery packs are located on two sides of the power management board, respectively.

19. The pressure washer of claim 17, wherein a cooling fan is disposed on the control board, and from the air inlet to the air outlet, the battery holder, the cooling fan, and the control board are located on the heat dissipation air path in sequence.

20. The pressure washer of claim 16, wherein a top cover is disposed on a top of the housing, the top cover is used for opening or closing the battery holder, and the battery pack is vertically inserted into the battery holder.
